(19) United States
(12) Patent Application Publication
(10) Pub. No.: US 2025/0178259 A1
(43) Pub. Date: Jun. 5, 2025

(54) MOLDING MANAGEMENT SYSTEM

(71) Applicant: SEIKO EPSON CORPORATION, Tokyo (JP)

(72) Inventor: Kosuke ATSUTA, SHIOJIRI-SHI (JP)

(21) Appl. No.: 18/961,593

(22) Filed: Nov. 27, 2024

(30) Foreign Application Priority Data
Nov. 30, 2023 (JP) 2023-202633

(51) Int. Cl. B29C 45/76

(52) U.S. Cl. CPC B29C 45/76; B29C 2945/76939

(57) ABSTRACT

A molding management system includes a server, and manages production of a product in an injection molding process. The server includes a storage unit that stores lot identification information and lot related information including one or more pieces of information related to the lot of the product. A control unit displays, on a terminal device, a lot search image for receiving a search operation of searching for the lot of the product from the terminal device. The control unit, when at least one piece of information among the one or more pieces of information included in the lot related information is received via the lot search image by the search operation, displays, on the terminal device, lot information indicating the lot identified by each of one or more pieces of the lot identification information associated with the at least one piece of information received.

The present application is based on, and claims priority from JP Application Serial Number 2023-202633, filed Nov. 30, 2023, the disclosure of which is hereby incorporated by reference herein in its entirety.

### BACKGROUND

### 1. Technical Field

This disclosure relates to a molding management system.

### 2. Related Art

Research and development have been conducted on a technology for managing production of a product in production processes including an injection molding process of the product by an injection molding device in which a material containing metal powder is used.

In this regard, a system has been known in which information about products molded by a plurality of injection molding devices can be searched for on a lot-by-lot basis (see JP 2006-018576 A).

In the system described in JP 2006-018576 A, when information about products of a certain lot was searched for, it was necessary to search for the information by using lot identification information for identifying the lot. However, it is difficult for a user of the system to keep memorizing lot identification information of a lot which is not being produced, a lot which does not exist in a vicinity, and the like. For this reason, in the system, it was difficult to cause the user to search for information about products of a lot desired by the user in some cases.

### SUMMARY

An aspect of the present disclosure for solving the above-described problems is a molding management system that includes a server communicably connected to a terminal device and manages production of a product in a production process including an injection molding process of the product by an injection molding device, wherein the server includes a storage unit that stores lot identification information for identifying a lot of the product and lot related information including one or more pieces of information related to the lot of the product in association with each other, and a control unit that displays, on the terminal device, a lot search image for receiving a search operation of searching for the lot of the product from the terminal device, and the control unit, when at least one piece of information among the one or more pieces of information included in the lot related information is received via the lot search image by the search operation, displays, on the terminal device, lot information indicating the lot identified by each of one or more pieces of the lot identification information associated with the at least one piece of information received.

### BRIEF DESCRIPTION OF THE DRAWINGS

FIG. 1 is a diagram illustrating an example of a configuration of a molding management system 1.

FIG. 2 is a diagram illustrating an example of a main menu image P1.

FIG. 3 is a diagram illustrating an example of a terminal image P2.

FIG. 4 is a diagram illustrating an example of a lot search image P3.

FIG. 5 is a diagram illustrating an example of a detailed information display image P4.

FIG. 6 is a diagram illustrating an example of a state in which lot information indicating a lot-completed lot is selected in a search result display region RG2.

FIG. 7 is a diagram illustrating an example of the lot search image P3 immediately after lot information of each of one or more lots started within a target period is searched for.

FIG. 8 is a diagram illustrating an example of a lot stopping reason reception image P5 displayed on a terminal device 40 when a selection operation is performed on a button B43 illustrated in FIG. 7.

FIG. 9 is a diagram illustrating an example of the search result display region RG2 immediately after a selection operation is performed on a button B51 illustrated in FIG. 8.

FIG. 10 is a diagram illustrating an example of a state in which lot information indicating each of four lot-stopped lots displayed in the search result display region RG2 illustrated in FIG. 9 is selected.

FIG. 11 is a diagram illustrating another example of the lot search image P3 immediately after lot information of each of one or more lots started within a target period is searched for.

FIG. 12 is a diagram illustrating an example of a lot deletion reason reception image P6 displayed on the terminal device 40 when a selection operation is performed on a button B45 illustrated in FIG. 11.

FIG. 13 is a diagram illustrating still another example of the lot search image P3 immediately after lot information of each of one or more lots started within a target period is searched for.

FIG. 14 is a diagram illustrating an example of a print user information reception image P7 displayed on the terminal device 40 when a selection operation is performed on a button B46 illustrated in FIG. 13.

FIG. 15 is a diagram illustrating an example of a hardware configuration of a server 30.

FIG. 16 is a diagram illustrating an example of a functional configuration of the server 30.

FIG. 17 is a diagram illustrating an example of a flow of processing in which the server 30 performs a lot search.

### DESCRIPTION OF EMBODIMENTS

### Embodiments

Embodiments of the present disclosure will be described below with reference to the drawings.

### Overview of Molding Management System

First, an overview of a molding management system according to an embodiment will be described.

The molding management system according to the embodiment manages production of a product in a production process including an injection molding process of the product by an injection molding device. The molding management system includes a server. The server is communicatively coupled to a terminal device. Further, the server includes a storage unit and a control unit. The storage unit stores lot identification information for identifying a lot of a product and lot related information including one or more pieces of information related to the lot of the product in association with each other. The control unit causes the terminal device to display a lot search image for receiving a search operation of searching for the lot of the product from the terminal device. Then, when at least one piece of information among the one or more pieces of information included in the lot related information is received via the lot search image by the search operation, the control unit causes the terminal device to display lot information indicating a lot identified by each of one or more pieces of the lot identification information associated with the at least one piece of information received.

Accordingly, the molding management system according to the embodiment can cause a user to use information other than the lot identification information as a search key when the user is caused to search for a lot desired by the user. As a result, the molding management system can cause the user to easily search for information about a product of a lot desired by the user.

In the following description, each of a configuration of an injection molding system according to the embodiment, and processing performed by the server included in the injection molding system will be described in detail.

### Configuration of Molding Management System

Hereinafter, the configuration of the molding management system according to the embodiment will be described using a molding management system 1 as an example.

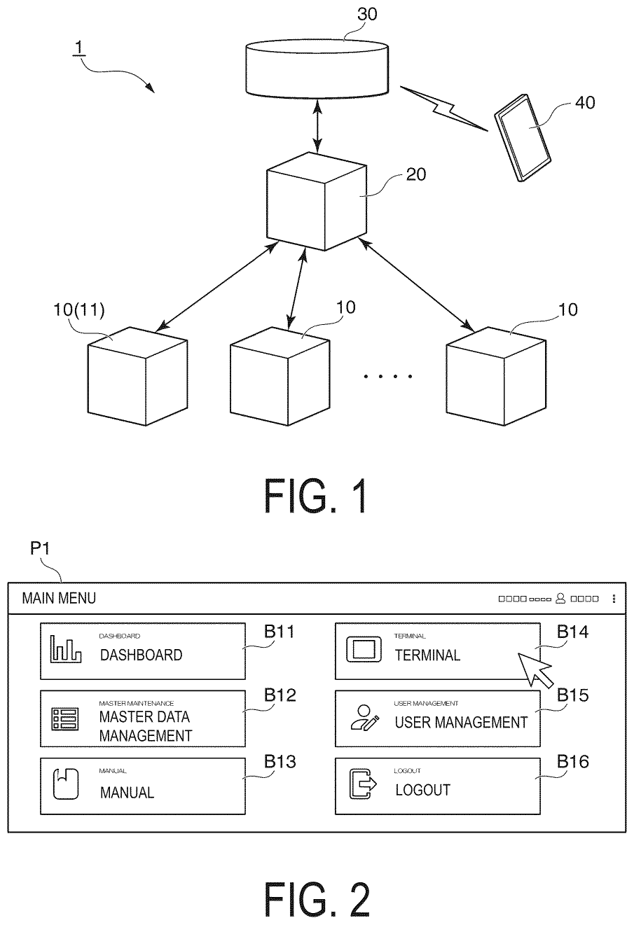

FIG. 1 is a diagram illustrating an example of a configuration of the molding management system 1.

The molding management system 1 is a type of manufacturing execution system (MES). For example, the molding management system 1 includes one or more managed devices 10, an information processing device 20, and the server 30. Note that the molding management system 1 may be configured without including some or all of the one or more managed devices 10. In addition, the molding management system 1 may be configured without including the information processing device 20. In the following description, as an example, a case in which the molding management system 1 includes a plurality of the managed devices 10 as the one or more managed devices 10 will be described.

Each of the plurality of managed devices 10 included in the molding management system 1 is a device managed by the molding management system 1. In FIG. 1, the plurality of managed devices 10 are denoted by reference numerals identical to each other for convenience of description. However, some or all of the plurality of managed devices 10 may be devices of types different from each other. The plurality of managed devices 10 include at least one injection molding device that performs injection molding of a product using resin such as plastic. The injection molding device 11 illustrated in FIG. 1 is an example of such an injection molding device. Note that the plurality of managed devices 10 may include an injection molding device that performs metal injection molding (MIM) of a product. In the following description, for convenience of description, injection molding of a product using resin such as plastic will be simply referred to as injection molding. In addition, in the following description, an injection molding device that performs injection molding of a product using resin such as plastic is simply referred to as an injection molding device. Further, in addition to the injection molding device, the plurality of managed devices 10 include, for example, peripheral equipment of the injection molding device, and the like. Examples of the peripheral equipment of the injection molding device include, but are not limited to, a material supply device for supplying the injection molding device with a material to be used for injection molding of a product by the injection molding device, a transport device for transporting the product injection-molded by the injection molding device, a cleaning device for cleaning the product injection-molded by the injection molding device, and a sintering device for sintering the product after cleaned by the cleaning device. Additionally, at least one injection molding device included in the plurality of managed devices 10 may be a device that performs injection molding using a material other than resin and metal.

The molding management system 1 manages production of a product in a production process including an injection molding process of the product by the injection molding device included in the plurality of managed devices 10. Here, each of the injection molding devices included in the plurality of managed devices 10 may have any configuration as long as the configuration enables production of a product by injection molding. In the following description, for convenience of description, performing injection molding once for a product by an injection molding device will be referred to as one shot. In this case, for example, two shots refer to performing injection molding twice for a product by the injection molding device.

The information processing device 20 acquires state information indicating a state of the managed device 10 from the managed device 10 for each of the plurality of managed devices 10. For example, the information processing device 20 acquires state information about the injection molding device 11 from the injection molding device 11. Such state information includes a time stamp indicating date and time when the state information is acquired by the information processing device 20. Further, state information may include device identification information for identifying the managed device 10 in the state indicated by the state information. In addition, the state information includes detection information detected by each of one or more various sensors attached to the managed device 10. The detection information includes, for example, information indicating temperature, information indicating pressure, information indicating a current value, information indicating a voltage value, and the like. That is, the one or more various sensors are, for example, a thermometer, a pressure gauge, an ammeter, a voltmeter, and the like, but are not limited thereto. Note that the detection information may be configured to include other information detected by a sensor instead of some or all of these pieces of information or in addition to all of these pieces of information. Further, the state information includes operation state information indicating an operation state of the managed device 10. The operation state information indicating the operation state of the managed device 10 may be any information as long as the information includes information indicating whether the managed device is in operation or not. Further, such acquisition of the state information by the information processing device 20 may be performed periodically or non-periodically. In the following description, as an example, a case in which state information is acquired by the information processing device 20 every time the above-described one shot is performed will be described. When certain state information is acquired, the information processing device 20 outputs the acquired state information to the server 30. Thus, the information processing device 20 can cause the server 30 to store the acquired state information.

Although the information processing device 20 is, for example, a workstation, a desktop personal computer (PC), a notebook PC, or the like, the present disclosure is not limited thereto. The information processing device 20 is communicably connected to each of the plurality of managed devices 10 through wired or wireless communication. A communication network coupling the information processing device 20 and each of the plurality of managed devices 10 is, for example, a local area network (LAN) in a facility in which the plurality of managed devices 10 are installed, but is not limited thereto. The communication network may be another communication network such as the Internet or a mobile communication network.

The server 30 stores state information acquired by the information processing device 20. For example, when certain state information is acquired from the information processing device 20, the server 30 stores the acquired state information. Here, when the server 30 has already stored other state information including device identification information included in the state information, the server 30 replaces the already stored state information with the newly acquired state information. Accordingly, the server 30 can constantly keep state information indicating a state of the managed device 10 indicated by the device identification information as latest state information. Note that the server 30 may be configured to store every acquired state information without performing such replacement. In addition, the server 30 may be configured, even when such replacement is performed, to newly store state information before the replacement as history information indicating a history of state of the managed device 10.

In addition, in response to a request from the terminal device communicably connected to the server 30, the server 30 causes a display unit of the terminal device to display various images based on state information stored in the server 30. In the following description, a case in which the server 30 is communicatively coupled to the terminal device 40 as illustrated in FIG. 1 will be described as an example. Note that, in the embodiment, a process related to logging-in to the server 30 by the terminal device 40 is a known process, and thus a description thereof will be omitted. In addition, in the following description, for convenience of description, reception of an operation by the server 30 from the terminal device 40 via an image displayed on the terminal device 40 is simply referred to as reception of an operation by the server 30. That is, in the following description, a fact that the server 30 performs a certain process in response to a received operation means that the server 30 performs the process in response to the operation received from the terminal device 40 via an image displayed on the terminal device 40.

Further, the server 30 receives various types of information in response to a received operation. For example, the server 30 stores master data including various types of information about a product by the injection molding device 11 in response to a received operation. The master data includes, for example, product identification information for identifying various products produced by the injection molding device 11, production quantity planned value information indicating a planned value of a production quantity of a product identified by each piece of the product identification information, mold identification information for identifying a mold used for production of the product identified by each piece of the product identification information, and the like. A data structure of the master data may be any structure. For example, various types of information included in the master data are included in the master data as information associated with the product identification information.

In addition, in response to a received operation, the server 30 causes the display unit of the terminal device 40 to display a lot search image for receiving a search operation of searching for a lot of a product. The display unit is, for example, a display of the terminal device 40, a display device communicably connected to the terminal device 40, or the like, but is not limited thereto. In the following description, as an example, a case in which the display unit is a display of the terminal device 40 will be described. In addition, in the following description, for convenience of description, causing a certain image to be displayed on the display unit is referred to as causing the image to be displayed on the terminal device 40. A lot search image is an image for receiving various types of information usable as search keys by the above-described search operation. Note that, in the following description, a lot of a product will be simply referred to as a lot, for convenience of description. A lot is a collection of one or more products to which lot identification information is assigned for management reasons. Therefore, in the following description, for convenience of description, a product to which lot identification information for identifying a certain lot is assigned is referred to as a product of the lot. Lot identification information may be any information as long as a lot can be identified with the information, and for example, may be an identifier (ID) for identifying the lot, a character string for identifying the lot, or other information with which the lot can be identified.

Here, in a molding management system other than the molding management system 1, when information of a product of a certain lot is searched for, it was necessary to search for the information using lot identification information for identifying the lot as a search key. However, it is difficult for a user of the molding management system to continuously memorize lot identification information about a lot which is not being produced, a lot which does not exist in a vicinity, and the like. Therefore, in the molding management system, it was difficult to cause the user to search for information about a product of a lot desired by the user in some cases.

Therefore, the server 30 of the molding management system 1 stores lot identification information and lot related information including one or more pieces of information related to a lot in association with each other. Accordingly, in the server 30, when information about a product of a certain lot is searched for, together with lot identification information for identifying the lot, each of one or more pieces of information included in lot related information associated with the lot identification information can be used as a search key for searching for the lot. In other words, in a lot search image, in addition to lot identification information, each of one or more pieces of information included in lot related information can be used as a search key for use in a lot search. In the following description, for convenience of description, information in which lot identification information for identifying a certain lot and lot related information including one or more pieces of information related to the lot are associated with each other is referred to as lot information indicating the lot. That is, when at least one piece of information among one or more pieces of information included in lot related information is received via a lot search image by a search operation, the server 30 causes the terminal device 40 to display lot information indicating a lot identified by each of one or more pieces of lot identification information associated with the at least one piece of information received. As a result, the server 30 can cause a user to easily search for information about a product of a lot desired by the user. Therefore, the server 30 stores one or more pieces of lot information for each piece of lot identification information.

For example, the server 30 receives an operation via the main menu image P1 as illustrated in FIG. 2 to cause a lot search image to be displayed on the terminal device 40. FIG. 2 is a diagram illustrating an example of the main menu image P1.

When a predetermined main menu image display operation is received, the server 30 causes the main menu image P1 to be displayed on the terminal device 40. In the example illustrated in FIG. 2, the main menu image P1 includes six buttons of a button B11 to a button B16.

The button B11 is a button for causing a dashboard image to be displayed. When the server 30 receives an operation on the button B11 via the terminal device 40, the server 30 generates a dashboard image and causes the generated dashboard image to be displayed on the terminal device 40. Here, during operation of an injection molding device designated by a user of the terminal device 40, the dashboard image is an image in which information necessary for the user to manage production of a product by the injection molding device is displayed.

The button B12 is a button for causing a master data management image to be displayed. When the server 30 receives an operation on button B12 via the terminal device 40, the server 30 generates a master data management image and causes the generated master data management image to be displayed on the terminal device 40. Here, the master data management image is an image for receiving an operation of inputting, changing, deleting, or the like of the master data described above. The server 30 can perform generation, change, deletion, and the like of the master data in response to an operation on the master data management image via the terminal device 40. When a master data is generated, the server 30 stores the generated master data. Further, when a master data is changed, the server 30 updates the stored master data with the master data after the change.

The button B13 is a button for causing a manual image to be displayed. When the server 30 receives an operation on the button B13 via the terminal device 40, the server 30 generates a manual image and causes the generated manual image to be displayed on the terminal device 40. Here, the manual image is an image for receiving an operation of causing a manual for an operation method of the molding management system 1 to be displayed.

The button B14 is a button for causing the terminal image P2 to be displayed. When the server 30 receives an operation on the button B14 via the terminal device 40, the server 30 generates the terminal image P2 and causes the generated terminal image to be displayed on the terminal device 40. Here, the terminal image P2 is an image for receiving an operation for causing each of various update-related functions included in the server 30 to be performed. A certain type of the update-related function is a function of performing input, change, deletion, or the like of information according to the type.

The button B15 is a button for causing a user management image to be displayed. When the server 30 receives an operation on the button B15 via the terminal device 40, the server 30 generates a user management image and causes the generated user management image to be displayed on the terminal device 40. Here, the user management image is an image for receiving an operation of performing input, change, deletion, display, or the like of information related to a user out of information stored in the server 30.

The button B16 is a button for receiving an operation of causing the terminal device 40 to log out from the server 30. When the server 30 receives an operation on the button B16 via the terminal device 40, the server 30 causes the terminal device 40 to log out.

Note that in the embodiment, a description of each of the dashboard image, the master data management image, the manual image, and the user management image is omitted.

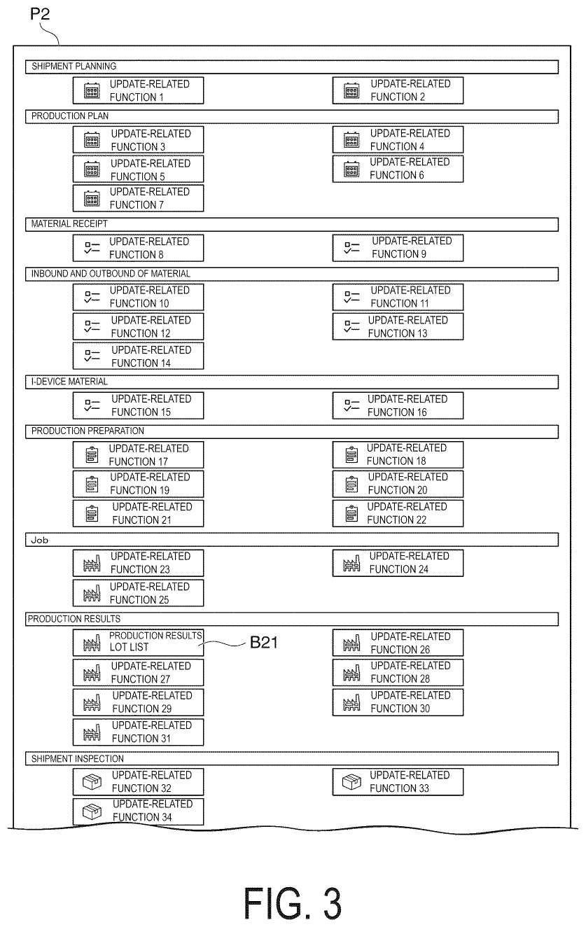

FIG. 3 is a diagram illustrating an example of the terminal image P2. As illustrated in FIG. 3, the terminal image P2 includes buttons for receiving operations of respectively causing a plurality of the update-related functions to be performed. One of such buttons is a button B21.

The button B21 is a button for receiving an operation of causing the lot search image P3 which is an example of the lot search image described above to be displayed. When the server 30 receives an operation on the button B21 via the terminal device 40, the server 30 generates the lot search image P3 and causes the generated lot search image P3 to be displayed on the terminal device 40.

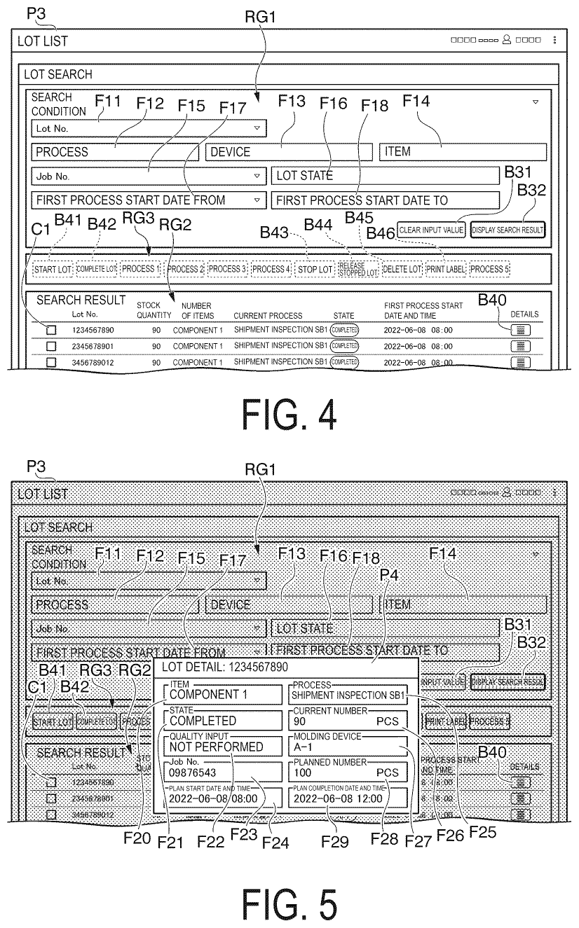

FIG. 4 is a diagram illustrating an example of the lot search image P3. In the example illustrated in FIG. 4, the lot search image P3 includes a lot search region RG1, the search result display region RG2, and a processing button group region RG3.

The lot search region RG1 includes, for example, each of an input field F11 to an input field F18, a button B31, and a button B32. Note that the lot search region RG1 may be configured to include another GUI capable of receiving an operation of searching for a lot instead of some or all of these graphical user interfaces (GUIs) or in addition to all of these GUIs. Here, the above-described search operation refers to an individual operation received by the lot search region RG1.

The input field F11 is a field in which lot identification information for identifying a lot desired by a user is input. A character string “LOT NO.” superimposed on the input field F11 in FIG. 4 is a character string for indicating to the user that information input in the input field F11 is lot identification information. In the example illustrated in FIG. 4, nothing is input in the input field F11. Note that the lot identification information may be input in the input field F11 by selecting the lot identification information from a pull-down menu, or may be directly input via an input device such as a keyboard.

The input field F12 is a field in which process information indicating a work process currently performed on a product of a lot desired by the user among various processes included in a production process is input. Therefore, in the example illustrated in FIG. 4, the process information is included in the lot related information described above, and a lot search can be performed using the process information as a search key. A character string “PROCESS” superimposed on the input field F12 in FIG. 4 is a character string for indicating to the user that information input in the input field F12 is process information. In this example, nothing is input in the input field F12. Note that the process information may be input in the input field F12 by selecting the process information from a pull-down menu, or may be directly input via an input device such as a keyboard.

The input field F13 is a field in which injection molding device identification information for identifying an injection molding device that has molded a product of a lot desired by the user or an injection molding device that is scheduled to mold a product of a lot desired by the user is input. Therefore, in the example illustrated in FIG. 4, injection molding device identification information is included in the lot related information, and a lot search can be performed by using the injection molding device identification information as a search key. A character string “DEVICE” superimposed on the input field F13 in FIG. 4 is a character string for indicating to the user that information input in the input field F13 is injection molding device identification information. In this example, nothing is input in the input field F13. Note that the injection molding device identification information may be input in the input field F13 by selecting the injection molding device identification information from a pull-down menu, or may be directly input via an input device such as a keyboard.

The input field F14 is a field in which product type information indicating a type of product of a lot desired by the user is input. Therefore, in the example illustrated in FIG. 4, the product type information is included in the lot related information, and a lot search can be performed using the product type information as a search key. A character string “ITEM” superimposed on the input field F14 in FIG. 4 is a character string for indicating to the user that information input in the input field F14 is product type information. In this example, nothing is input in the input field F14. Note that the product type information may be input in the input field F14 by selecting the product type information from a pull-down menu, or may be directly input via an input device such as a keyboard.

The input field F15 is a field in which information for identifying a higher group to which a lot desired by the user belongs is input. In the following description, as an example, a description will be given of a case in which the group is a manufacturing lot. Thus, in the following description, the information will be referred to as manufacturing lot identification information. Therefore, in the example illustrated in FIG. 4, the manufacturing lot identification information is included in the lot related information, and a lot search can be performed using the manufacturing lot identification information as a search key. Note that the group may be another group such as a work shift of a manager who manages production of products of a lot. A character string “JOB NO.” superimposed on the input field F15 in FIG. 4 is a character string for indicating to the user that information input in the input field F15 is manufacturing lot identification information. In this example, nothing is input in the input field F15. Note that the manufacturing lot identification information may be input in the input field F15 by selecting the manufacturing lot identification information from a pull-down menu, or may be directly input via an input device such as a keyboard.

The input field F16 is a field in which lot state information indicating a state of a lot desired by the user is input. Therefore, in the example illustrated in FIG. 4, the lot state information is included in the lot related information, and a lot search can be performed using the lot state information as a search key. A character string “LOT STATE” superimposed on the input field F16 in FIG. 4 is a character string for indicating to the user that information input in the input field F16 is lot state information. In this example, nothing is input in the input field F16. The lot state information is, for example, information indicating any one of a state in which a lot is stopped, a state in which a lot is in process, a state in which a lot is waiting, and a state in which a lot is completed. In the following description, for convenience of description, a state in which a lot is stopped will be simply referred to as lot-stopped. In addition, in the following description, for convenience of description, a state in which a lot is being prepared will be simply referred to as lot-in-process. In addition, in the following description, for convenience of description, a state in which a lot is waiting will be simply referred to as lot-waiting. In addition, in the following description, for convenience of description, a state in which a lot is completed will be simply referred to as lot-completed. Note that the lot state information may be input in the input field F16 by selecting the lot state information from a pull-down menu, or may be directly input via an input device such as a keyboard.

The input field F17 and the input field F18 are fields in which period information indicating a period including a date when production of a product of a lot desired by the user is started is input. Therefore, in the example illustrated in FIG. 4, information indicating the date is included in the lot related information, and a lot search can be performed using the information as a search key. A character string “FIRST PROCESS START DATE FROM” superimposed on the input field F17 in FIG. 4 is a character string for indicating to the user that information input in the input field F17 is start date and time information indicating date and time at which the period starts. A character string “FIRST PROCESS START DATE TO” superimposed on the input field F18 in FIG. 4 is a character string for indicating to the user that information input in the input field F18 is end date and time information indicating date and time at which the period ends. In this example, nothing is input in the input field F17 and the input field F18. In the following description, for convenience of description, a period from date and time indicated by the start date and time information input in the input field F17 to date and time indicated by the end date and time information input in the input field F18 will be referred to as a target period. In addition, in the following description, for convenience of description, the start date and time information input in the input field F17 is referred to as target start date and time information, and the end date and time information input in the input field F18 is referred to as target end date and time information. Note that the start date and time information may be input in the input field F17 by selecting a date using a calendar or the like, selecting a time using a watch or the like, or by direct input using an input device such as a keyboard. Further, the end date and time information may be input in the input field F18 by selecting a date using a calendar or the like, selecting a time using a watch or the like, or by direct input using an input device such as a keyboard. Note that the start date and time information may be information indicating only a date. In addition, the end date and time information may be information indicating only a date.

The button B31 is a button for receiving an operation of deleting pieces of information respectively input in some or all of the input field F11 to the input field F18. In other words, the button B31 is a button for receiving an operation of clearing pieces of information respectively input in some or all of the input field F11 to the input field F18. When a selection operation is performed on the button B31, the server 30 deletes pieces of information respectively input in some or all of the input field F11 to the input field F18. Here, in the embodiment, the selection operation is a click, a tap, or the like, but is not limited thereto.

The button B32 is a button for receiving an operation of performing a lot search based on pieces of information respectively input in some or all of the input field F11 to the input field F18. When a selection operation is performed on the button B32, the server 30 extracts one or more pieces of lot information including pieces of information respectively input in some or all of the input field F11 to the input field F18 from one or more pieces of lot information stored in advance. After the one or more pieces of lot information are extracted, the server 30 causes a list of the one or more pieces of extracted lot information to be displayed in the search result display region RG2. In the following description, for convenience of description, the list will be simply referred to as a lot information list.

Here, the lot information is, for example, information generated or updated based on information received from the user via one of the update-related functions that can be performed in the terminal image P2, and is information stored in the server 30. Certain lot information includes, for example, lot identification information for identifying a lot indicated by the lot information, stock quantity information indicating a stock quantity of the lot, product type information indicating a type of product of the lot, process information indicating a work process currently performed on the product of the lot, lot state information indicating a state of the lot, start date and time information indicating date and time at which production of the product of the lot is started, and the like. The lot information may be configured to include other information related to the lot in place of some or all of these pieces of information, or in addition to all of these pieces of information.

The search result display region RG2 is a region in which a lot information list is displayed as a result of a selection operation performed on the button B32. When a selection operation is not performed on the button B32, a list of all lot information stored in the server 30 may be displayed in the search result display region RG2, or nothing may be displayed. In the example illustrated in FIG. 4, the list is displayed in the search result display region RG2. Note that the number of pieces of lot information to be displayed in the search result display region RG2 may be determined in advance. In this case, a button for causing lot information that cannot be displayed in the search result display region RG2 to be displayed is included in the search result display region RG2.

In the example illustrated in FIG. 4, as described above, the lot information displayed in the search result display region RG2 includes each of the lot identification information, the stock quantity information, the product type information, the process information, the lot state information, and the start date and time information. For example, the lot information displayed at an uppermost row of the search result display region RG2 illustrated in FIG. 4 includes each of “1234567890” as the lot identification information, “90” as the stock quantity information, “COMPONENT 1” as the product type information, “SHIPMENT INSPECTION SB1” as the process information, the lot state information indicating lot-completed, and “Jun. 8, 2022 08:00” as the start date and time information. Here, “90” is the stock quantity information indicating 90 pieces. “Jun. 8, 2022 08:00” is the start date and time information indicating Jun. 8, 2022, 08:00. The start date and time information is an example of information indicating a date when production of a product of a lot desired by the user is started.

A detail display button is displayed in association with each piece of lot information displayed in the search result display region RG2. A detail display button displayed in association with some lot information is a button for receiving an operation of causing the terminal device 40 to display a detailed information display image in which detailed information of a lot indicated by the lot information is displayed. The detailed information displayed in the detailed information display image includes at least a part of information displayed in the search result display region RG2 out of information included in the lot information, and at least a part of information not displayed in the search result display region RG2 out of the information included in the lot information.

For example, a button B40 illustrated in FIG. 4 is an example of a detail display button displayed in association with the lot information displayed at the uppermost row of the search result display region RG2 illustrated in FIG. 4. When a selection operation is performed on the button B40, the server 30 causes the terminal device 40 to display the detailed information display image P4 which is an example of a detailed information display image in which detailed information of a lot indicated by the lot information is displayed. FIG. 5 is a diagram illustrating an example of the detailed information display image P4. In the example illustrated in FIG. 5, the detailed information display image P4 includes each of a display field F20 to a display field F29.

The display field F20 is a field in which product type information included in lot information displayed in association with the button B40 is displayed. Therefore, in the example illustrated in FIG. 5, “COMPONENT 1” is displayed as the product type information in the display field F20. That is, in this example, the display field F20 is a field for displaying the product type information as one piece of information displayed in the search result display region RG2 out of the information included in the lot information.

The display field F21 is a field in which lot state information included in the lot information displayed in association with the button B40 is displayed. For this reason, in the example illustrated in FIG. 5, lot state information indicating lot-completed is displayed in the display field F21. That is, in this example, the display field F21 is a field for displaying the lot state information as one piece of the information displayed in the search result display region RG2 out of the information included in the lot information.

The display field F22 is a field in which quality information of a product of a lot indicated by the lot information displayed in association with the button B40 is displayed. That is, in the example illustrated in FIG. 5, the lot information includes the quality information. The quality information is information indicating a result of a quality inspection performed on the product. However, when a quality inspection is not performed on the product, the quality information is information indicating that a quality inspection is not performed on the product. In the example illustrated in FIG. 5, the quality information indicating that a quality inspection is not performed on the product is displayed in the display field F22. That is, in this example, the display field F22 is a field for displaying the quality information as one piece of the information not displayed in the search result display region RG2 out of the information included in the lot information. Therefore, in this example, the lot related information of the lot information includes the quality information about the product.

The display field F23 is a field in which manufacturing lot identification information for identifying a higher group to which the lot indicated by the lot information displayed in association with the button B40 belongs is displayed. Therefore, in the example illustrated in FIG. 5, “09876543” is displayed as the manufacturing lot identification information in the display field F23. That is, in this example, the display field F23 is a field for displaying the manufacturing lot identification information as one piece of the information not displayed in the search result display region RG2 out of the information included in the lot information. Therefore, in this example, the lot related information of the lot information includes the manufacturing lot identification information for identifying the higher group to which the lot belongs.

The display field F24 is a field in which start date and time information indicating date and time when production of the product of the lot indicated by the lot information displayed in association with the button B40 is started is displayed. Therefore, in the example illustrated in FIG. 5, “Jun. 8, 2022 08:00” is displayed as the start date and time information in the display field F24. That is, in this example, the display field F24 is a field for displaying the start date and time information as one piece of the information displayed in the search result display region RG2 out of the information included in the lot information.

The display field F25 is a field in which process information indicating a work process currently performed on the product of the lot indicated by the lot information displayed in association with the button B40 is displayed. Therefore, in the example illustrated in FIG. 5, “SHIPMENT INSPECTION SB1” is displayed as the process information in the display field F25. That is, in this example, the display field F25 is a field for displaying the process information as one piece of the information displayed in the search result display region RG2 out of the information included in the lot information.

The display field F26 is a field in which stock quantity information indicating a stock quantity of the lot indicated by the lot information displayed in association with the button B40 is displayed. Therefore, in the example illustrated in FIG. 5, “90” is displayed as the stock quantity information in the display field F26. That is, in this example, the display field F26 is a field for displaying the stock quantity information as one piece of the information displayed in the search result display region RG2 out of the information included in the lot information.

The display field F27 is a field in which injection molding device identification information for identifying an injection molding device that has molded the product of the lot indicated by the lot information displayed in association with the button B40 or an injection molding device that is scheduled to mold the product of the lot is displayed. Therefore, in the example illustrated in FIG. 5, “A−1” is displayed as the injection molding device identification information in the display field F27. That is, in this example, the display field F27 is a field for displaying the injection molding device identification information as one piece of the information not displayed in the search result display region RG2 out of the information included in the lot information. Therefore, in this example, the lot related information of the lot information includes the injection molding device identification information.

The display field F28 is a field in which production quantity planned value information indicating a planned value of a production quantity of the product of the lot indicated by the lot information displayed in association with the button B40 is displayed. Therefore, in the example illustrated in FIG. 5, “100” is displayed as the production quantity planned value information in the display field F28. “100” as the production quantity planned value information indicates that a planned value indicated by the production quantity planned value information is 100. That is, in this example, the display field F28 is a field for displaying the production quantity planned value information as one piece of the information not displayed in the search result display region RG2 out of the information included in the lot information. Therefore, in this example, the lot related information of the lot information includes the production quantity planned value information.

The display field F29 is a field in which end date and time information indicating date and time when production of the product of the lot indicated by the lot information displayed in association with the button B40 is ended or date and time when the production is scheduled to be ended is displayed. Therefore, in the example illustrated in FIG. 5, “Jun. 8, 2022 12:00” is displayed as the end date and time information in the display field F29. “Jun. 8, 2022 12:00” as the end date and time information indicates Jun. 8, 2022, 12:00. That is, in this example, the display field F24 is a field for displaying the end date and time information as one piece of the information not displayed in the search result display region RG2 out of the information included in the lot information. Therefore, in this example, the lot related information of the lot information includes the end date and time information indicating date and time when production of the product of the lot ended or date and time when production is scheduled to end.

Here, as described above, one or more pieces of information included in lot related information of certain lot information are associated with lot identification information included in the lot information. Therefore, the server 30 can extract the lot information from a storage region of the server 30 by using the lot identification information. This not only leads to simplification of a data structure of lot information, but also leads to a reduction in load of lot search processing by the server 30, which is useful.

As described above, when a selection operation is performed on a detail display button displayed in association with each piece of lot information in the search result display region RG2, the server 30 causes the terminal device 40 to display a detail information display image for causing detailed information of the lot information associated with a detail information display button on which the selection operation is performed to be displayed. Note that the detailed information display image may be configured to be superimposed on the lot search image P3 as illustrated in FIG. 5, or may be configured to be displayed in a predetermined region in the lot search image P3.

Further, when one or more pieces of lot information are displayed in the search result display region RG2, a check box for receiving an operation of selecting each of the one or more pieces of lot information is displayed. For example, a check box C1 illustrated in FIG. 4 is a check box for receiving an operation of selecting lot information displayed at the uppermost row of the search result display region RG2. Note that the search result display region RG2 may be configured such that a check box for receiving an operation of selecting all lot information displayed in the search result display region RG2 is displayed. Accordingly, the server 30 can reduce time and effort required for the user to select the lot information. In the following description, for convenience of description, an operation of selecting lot information via such a check box will be referred to as a lot information selection operation.

The processing button group region RG3 is a region in which a GUI is displayed that receives a processing performance operation of causing the server 30 to start performance of predetermined processing on a lot indicated by each of one or more pieces of lot information selected according to a received lot information selection operation from among one or more pieces of lot information displayed in the search result display region RG2. In the example illustrated in FIG. 4, eleven buttons are displayed as such GUIs in the processing button group region RG3. Then, in this example, the eleven buttons include six buttons from a button B41 to the button B46. In the embodiment, a description of buttons other than the six buttons among the eleven buttons is omitted.

The button B41 is a button for receiving a first processing performance operation of causing the server 30 to start performance of processing of changing lot state information of a lot-waiting lot among lots selected by the user in the search result display region RG2 to lot state information indicating lot-in-process. When predetermined first gray-out conditions are satisfied, the server 30 grays out the button B41 and does not receive a selection operation on the button B41. On the other hand, when the first gray-out conditions are not satisfied, the server 30 cancels gray-out of the button B41 and receives a selection operation on the button B41. When a selection operation is performed on the button B41, the server 30 performs processing of changing lot state information of a lot-waiting lot among lots selected by the user in the search result display region RG2 to lot state information indicating lot-in-process. Here, the first gray-out conditions are, for example, conditions including two conditions of the following condition 1A and condition 1B.

The condition 1A: lots selected by the user in the search result display region RG2 include a lot in a state other than lot-waiting

The condition 1B: no lot is selected by the user in the search result display region RG2

The server 30 determines that the first gray-out conditions are satisfied, when any one of the condition 1A and the condition 1B is satisfied. On the other hand, when both the condition 1A and the condition 1B are not satisfied, the server 30 determines that the first gray-out conditions are not satisfied.

The button B42 is a button for receiving a second processing performance operation of causing the server 30 to start performance of processing of changing lot state information of a lot selected by the user in the search result display region RG2 to lot state information indicating lot-completed. When predetermined second gray-out conditions are satisfied, the server 30 grays out the button B42 and does not receive a selection operation on the button B42. On the other hand, when the second gray-out conditions are not satisfied, the server 30 cancels gray-out of the button B42 and receives a selection operation on the button B42. When a selection operation is performed on the button B42, the server 30 performs processing of changing lot state information of a lot selected by the user in the search result display region RG2 to lot state information indicating lot-completed. Here, the second gray-out conditions are, for example, conditions including two conditions of the following condition 2A and condition 2B.

The condition 2A: lots selected by the user in the search result display region RG2 include a lot-completed lot

The condition 2B: no lot is selected by the user in the search result display region RG2

The server 30 determines that the second gray-out conditions are satisfied, when any one of the condition 2A and the condition 2B is satisfied. On the other hand, when both the condition 2A and the condition 2B are not satisfied, the server 30 determines that the second gray-out conditions are not satisfied.

The button B43 is a button for receiving a third processing performance operation of causing the server 30 to start performance of processing of changing lot state information of a lot-in-process lot, and lot state information of a lot-waiting lot among lots selected by the user in the search result display region RG2 to lot state information indicating lot-stopped. When predetermined third gray-out conditions are satisfied, the server 30 grays out the button B43 and does not receive a selection operation on the button B43. On the other hand, when the third gray-out conditions are not satisfied, the server 30 cancels gray-out of the button B43 and receives a selection operation on the button B43. When a selection operation is performed on the button B43, the server 30 performs processing of changing lot state information of a lot-in-process lot, and lot state information of a lot-waiting lot, among lots selected by the user in the search result display region RG2, to lot state information indicating lot-stopped. Here, the third gray-out conditions are, for example, conditions including two conditions of the following condition 3A and condition 3B.

The condition 3A: lots selected by the user in the search result display region RG2 include a lot-stopped lot and a lot-waiting lot

The condition 3B: no lot is selected by the user in the search result display region RG2

The server 30 determines that the third gray-out conditions are satisfied, when any one of the condition 3A and the condition 3B is satisfied. On the other hand, when both the condition 3A and the condition 3B are not satisfied, the server 30 determines that the third gray-out conditions are not satisfied.

The button B44 is a button for receiving a fourth processing performance operation of causing the server 30 to start performance of processing of changing lot state information of a lot-stopped lot among lots selected by the user in the search result display region RG2 to lot state information indicating lot-in-process. When predetermined fourth gray-out conditions are satisfied, the server 30 grays out the button B44 and does not receive a selection operation on the button B44. On the other hand, when the fourth gray-out conditions are not satisfied, the server 30 cancels gray-out of the button B44 and receives a selection operation on the button B44. When a selection operation is performed on the button B44, the server 30 performs processing of changing lot state information of a lot-stopped lot among lots selected by the user in the search result display region RG2 to lot state information indicating lot-in-process. Here, the fourth gray-out conditions are, for example, a condition including two conditions of the following condition 4A and condition 4B.

The condition 4A: lots selected by the user in the search result display region RG2 include a lot in a state other than lot-stopped

The condition 4B: no lot is selected by the user in the search result display region RG2

The server 30 determines that the fourth gray-out conditions are satisfied, when any one of the condition 4A and the condition 4B is satisfied. On the other hand, when both the condition 4A and the condition 4B are not satisfied, the server 30 determines that the fourth gray-out conditions are not satisfied.

The button B45 is a button for receiving a fifth processing performance operation of causing the server 30 to start performance of deleting lot information of a lot selected by the user in the search result display region RG2. When a predetermined fifth gray-out condition is satisfied, the server 30 grays out the button B45 and does not receive a selection operation on the button B45. On the other hand, when the fifth gray-out condition is not satisfied, the server 30 cancels the gray-out of the button B45 and receives a selection operation on the button B45. When a selection operation is performed on the button B45, the server 30 performs processing of deleting lot information of a lot selected by the user in the search result display region RG2. Here, the fifth gray-out condition is, for example, a condition including the following condition 5.

The condition 5: no lot is selected by the user in the search result display region RG2

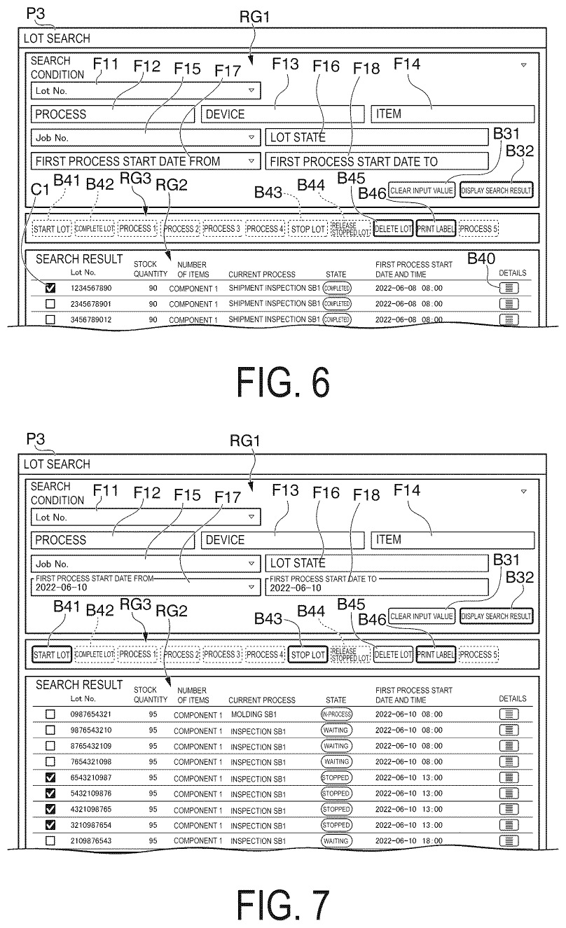

When the condition 5 is satisfied, the server 30 determines that the fifth gray-out condition is satisfied. On the other hand, when the condition 5 is not satisfied, the server 30 determines that the fifth gray-out condition is not satisfied. Note that the server 30 may be configured such that, when the fifth gray-out condition is not satisfied, in order to prevent a selection operation on the button B45 from being performed by mistake, a display mode of the button B45 is set to a display mode different from display modes of buttons other than the button B45 included in the processing button group region RG3. In this case, for example, as illustrated in FIG. 6, the server 30 sets a color of the button B45 to a color different from colors of the buttons other than the button B45 included in the processing button group region RG3. As a result, the server 30 can prevent a selection operation on the button B45 from being performed by mistake when the fifth gray-out condition is not satisfied. Note that in FIG. 6, such a difference in color between the buttons is indicated by hatching.

The button B46 is a button for receiving a sixth processing performance operation of causing the server 30 to start performance of processing of printing a label of a lot selected by the user in the search result display region RG2. When a predetermined sixth gray-out condition is satisfied, the server 30 grays out the button B46 and does not receive a selection operation on the button B46. On the other hand, when the sixth gray-out condition is not satisfied, the server 30 cancels gray-out of the button B46 and receives a selection operation on the button B46. When a selection operation is performed on the button B46, the server 30 performs processing of printing a label of a lot selected by the user in the search result display region RG2. Here, the sixth gray-out condition is, for example, a condition including the following condition 6.

The condition 6: no lot is selected by the user in the search result display region RG2

When the condition 6 is satisfied, the server 30 determines that the sixth gray-out condition is satisfied. On the other hand, when the condition 6 is not satisfied, the server 30 determines that the sixth gray-out condition is not satisfied.

Since the lot search image P3 includes the processing button group region RG3, the server 30 can reduce trouble of the user for causing the server 30 to perform predetermined processing on a lot desired by the user. As a result, the server 30 can reduce the user's time and effort required for lot management, and can improve the user's work efficiency. This is because, when the lot search image P3 does not include the processing button group region RG3, the user has to cause the server 30 to perform predetermined processing on a lot desired by the user via another update-related function of the server 30.

Here, FIG. 6 is a diagram illustrating an example of a state in which lot information indicating a lot-completed lot is selected in the search result display region RG2. In the example illustrated in FIG. 6, lot information displayed at the uppermost row of the search result display region RG2 is selected. Then, lot state information included in the lot information indicates lot-completed. In this case, since each of the fifth gray-out condition and the sixth gray-out condition is not satisfied, gray-out of each of the button B45 and the button B46 is canceled. In this case, since the first gray-out conditions to the fourth gray-out conditions are satisfied, each of the buttons B41 to B44 is grayed out. By such gray-out, the server 30 can suppress an erroneous operation by the user.

Further, FIG. 7 is a diagram illustrating an example of the lot search image P3 immediately after lot information of each of one or more lots started within a target period is searched for. In the example illustrated in FIG. 7, the target period is a period from Jun. 10, 2022 to Jun. 10, 2022. Therefore, in the search result display region RG2, lot information of each of the plurality of lots started on Jun. 10, 2022 is displayed. Further, in this example, a state of a lot indicated by lot information displayed at the uppermost row of the search result display region RG2 illustrated in FIG. 7 is lot-in-process. Further, in this example, states of lots indicated by pieces of lot information displayed in a second and subsequent rows from the top of the search result display region RG2 illustrated in FIG. 7 are all lot-waiting. Then, in this example, pieces of lot information respectively displayed at fifth, sixth, seventh, and eighth rows from the top of the search result display region RG2 illustrated in FIG. 7 are selected. As a result, each of the button B42 and the button B44 is grayed out. In this case, for example, when a selection operation is performed on the button B43, the server 30 causes the terminal device 40 to display the lot stopping reason reception image P5 for receiving a reason for changing lot state information included in the lot information to lot state information indicating lot-stopped.

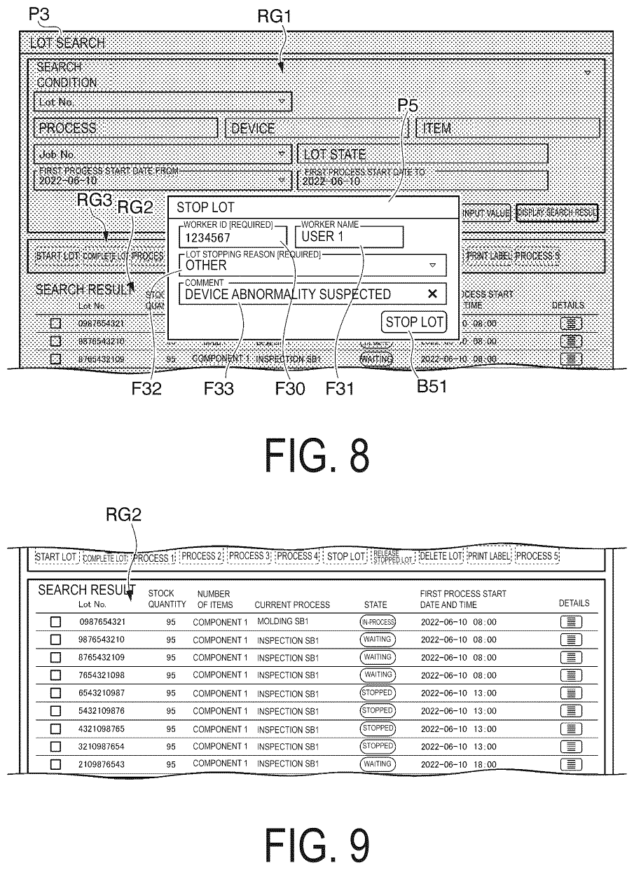

FIG. 8 is a diagram illustrating an example of the lot stopping reason reception image P5 displayed on the terminal device 40 when a selection operation is performed on the button B43 illustrated in FIG. 7.

The lot stopping reason reception image P5 includes, for example, an input field F30 to an input field F33 and the button B51. Note that the lot stopping reason reception image P5 may be configured to include other GUIs instead of some or all of these GUIs or in addition to all of these GUIs.

The input field F30 is a field in which user identification information for identifying a user is input. A character string “WORKER ID” superimposed on the input field F30 in FIG. 8 is a character string for indicating to the user that information input in the input field F30 is user identification information. Then, in the example illustrated in FIG. 8, “1234567” is input in the input field F30 as the user identification information. Note that the user identification information may be input in the input field F30 by selecting the user identification information from a pull-down menu, or may be directly input via an input device such as a keyboard.

The input field F31 is a field in which user name information indicating a name of the user is input. A character string “WORKER NAME” superimposed on the input field F31 in FIG. 8 is a character string for indicating to the user that the information input in the input field F31 is user name information. Then, in the example illustrated in FIG. 8, “USER 1” is input as the user name information in the input field F31. Note that the user name information may be input in the input field F31 by selecting the user name information from a pull-down menu, or may be directly input via an input device such as a keyboard.

The input field F32 is a field in which lot stopping reason information indicating a reason for stopping a lot is input. A character string “LOT STOPPING REASON” superimposed on the input field F32 in FIG. 8 is a character string for indicating to the user that information input in the input field F32 is lot stopping reason information. Then, in the example illustrated in FIG. 8, “OTHER” is input as the lot stopping reason information in the input field F32. Note that the lot stopping reason information may be input in the input field F32 by selecting the lot stopping reason information from a pull-down menu, or may be directly input via an input device such as a keyboard.

The input field F33 is a field in which a character string input by the user is input as an additional comment on stopping of a lot. In the example illustrated in FIG. 8, as an example, a character string “DEVICE ABNORMALITY SUSPECTED” is input in the input field F33.

The button B51 is a button for receiving an operation of confirming a change of lot state information included in each of one or more pieces of lot information selected in the search result display region RG2 to lot state information indicating lot-stopped. When a selection operation is performed on the button B51, the server 30 changes lot state information included in each of one or more pieces of lot information selected in the search result display region RG2 to lot state information indicating lot-stopped. Then, the server 30 deletes the display of the lot stopping reason reception image P5 from the terminal device 40.

FIG. 9 is a diagram illustrating an example of the search result display region RG2 immediately after a selection operation is performed on the button B51 illustrated in FIG. 8. As illustrated in FIG. 9, when a selection operation is performed on the button B51 illustrated in FIG. 8, lot state information included in each of the four pieces of lot information selected in FIG. 7 is changed from lot state information indicating lot-waiting to lot state information indicating lot-stopped.

In this way, the server 30 can change lot state information included in each of a plurality of pieces of selected lot information when a selection operation is performed on any one of the button B41 to the button B44. As a result, the server 30 can prevent the user from being caused to perform an operation of changing pieces of lot state information included in individual pieces of lot information one by one, and can reduce a workload of the user for lot management.

Note that in the search result display region RG2 illustrated in FIG. 9, no piece of lot information is selected. Therefore, all of the button B41 to the button B46 are grayed out.

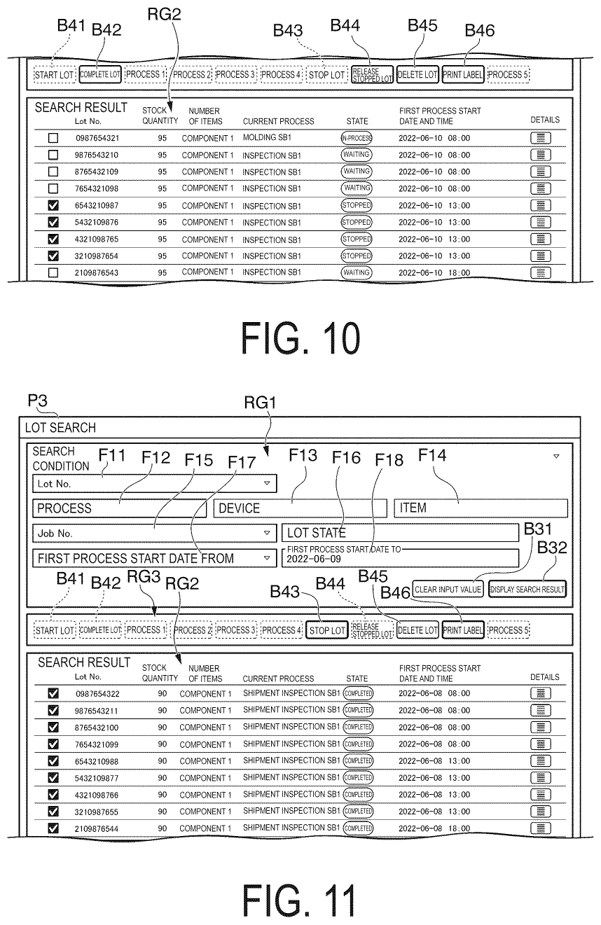

On the other hand, FIG. 10 is a diagram illustrating an example of a state in which pieces of lot information respectively indicating four lot-stopped lots displayed in the search result display region RG2 illustrated in FIG. 9 are selected. In this case, since the first gray-out conditions and the third gray-out conditions are satisfied, the button B41 and the button B43 are gray-out as illustrated in FIG. 10. However, in this case, since each of the second gray-out conditions and the fourth gray-out conditions to sixth gray-out condition is not satisfied, gray-out of each of the button B42 and the button B44 to the button B46 is canceled. Therefore, for example, when a selection operation is performed on the button B44, the server 30 changes pieces of lot state information included in the pieces of lot information respectively indicating the four lots from pieces of lot state information indicating lot-stopped to pieces of lot state information indicating lot-waiting. Note that this is a case in which a state of each of the four lots before becoming “lot-stopped” was lot-waiting.

Further, FIG. 11 is a diagram illustrating another example of the lot search image P3 immediately after lot information of each of one or more lots started within a target period is searched for. In the example illustrated in FIG. 11, start date and time information is not input in the input field F17. In addition, in this example, “Jun. 9, 2022” is input as the start date and time information in the input field F18. In this case, the target period is a period up to and including Jun. 9, 2022. Therefore, in the search result display region RG2, lot information of each of a plurality of lots started on and before Jun. 9, 2022 is displayed. In addition, in this example, a state of the lot indicated by each of all the pieces of lot information displayed in the search result display region RG2 illustrated in FIG. 11 is lot-completed. As a result, each of the button B41, the button B42, and the button B44 is grayed out. In this case, for example, when a selection operation is performed on the button B45, the server 30 causes the terminal device 40 to display the lot deletion reason reception image P6 for receiving a reason for deleting all the pieces of lot information.

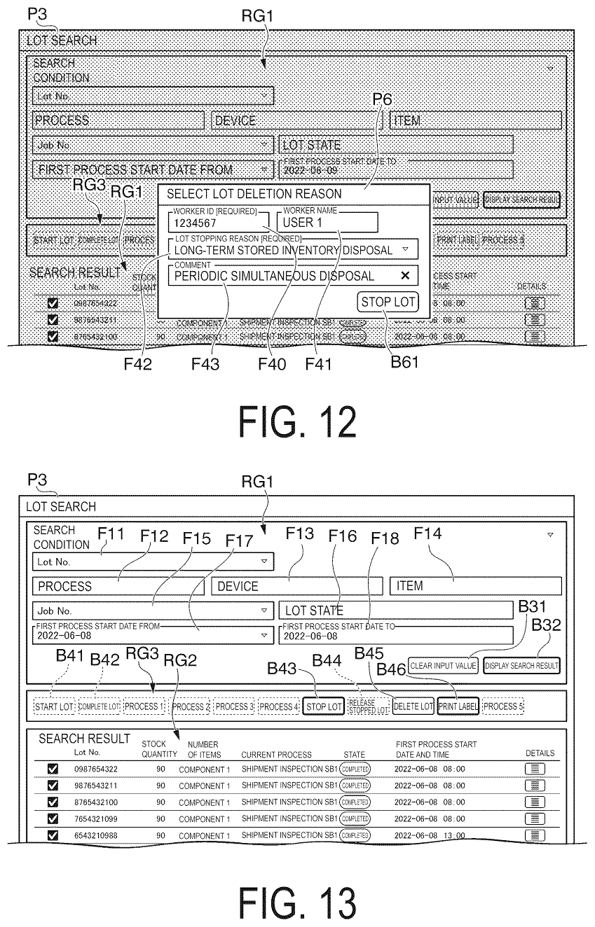

FIG. 12 is a diagram illustrating an example of the lot deletion reason reception image P6 displayed on the terminal device 40 when a selection operation is performed on the button B45 illustrated in FIG. 11.

The lot deletion reason reception image P6 includes, for example, an input field F40 to an input field F43 and a button B61. Note that the lot deletion reason reception image P6 may be configured to include other GUIs instead of some or all of these GUIs or in addition to all of these GUIs.

The input field F40 is a field in which user identification information for identifying a user is input. A character string “WORKER ID” superimposed on the input field F40 in FIG. 12 is a character string for indicating to the user that information input in the input field F40 is user identification information. Then, in the example illustrated in FIG. 12, “1234567” is input in the input field F40 as the user identification information. Note that the user identification information may be input in the input field F40 by selecting the user identification information from a pull-down menu, or may be directly input via an input device such as a keyboard.

The input field F41 is a field in which user name information indicating a name of a user is input. A character string “WORKER NAME” superimposed on the input field F41 in FIG. 12 is a character string for indicating to the user that information input in the input field F41 is user name information. Then, in the example illustrated in FIG. 12, “USER 1” is input as the user name information in the input field F41. Note that the user name information may be input in the input field F41 by selecting the user name information from a pull-down menu, or may be directly input via an input device such as a keyboard.

The input field F42 is a field in which lot deletion reason information indicating a reason for deleting a lot is input. A character string “LOT DELETION REASON” superimposed on the input field F42 in FIG. 12 is a character string for indicating to the user that information input in the input field F42 is lot deletion reason information. Then, in the example illustrated in FIG. 12, “LONG-TERM STORED INVENTORY DISPOSAL” is input in the input field F42 as the lot deletion reason information. Note that the lot deletion reason information may be input in the input field F42 by selecting the lot deletion reason information from a pull-down menu, or may be directly input via an input device such as a keyboard.

The input field F43 is a field in which a character string input by the user is input as an additional comment on deletion of a lot. In the example illustrated in FIG. 12, as an example, a character string “PERIODIC SIMULTANEOUS DISPOSAL” is input in the input field F43.

The button B61 is a button for receiving an operation of confirming deletion of one or more pieces of lot information selected in the search result display region RG2. When a selection operation is performed on the button B61, the server 30 deletes the one or more pieces of lot information selected in the search result display region RG2. Then, the server 30 deletes the display of the lot deletion reason reception image P6 from the terminal device 40. Note that all the pieces of lot information deleted in this manner may be deleted not only from the search result display region RG2 but also from the storage region of the server 30 or need not be deleted from the storage region of the server 30.

Further, FIG. 13 is a diagram illustrating still another example of the lot search image P3 immediately after lot information of each of one or more lots started within a target period is searched for. In the example illustrated in FIG. 13, the target period is a period from Jun. 8, 2022 to Jun. 8, 2022. Therefore, in the search result display region RG2, lot information of each of a plurality of lots started at Jun. 8, 2022 is displayed. In addition, in this example, a state of the lot indicated by each of all the pieces of lot information displayed in the search result display region RG2 illustrated in FIG. 13 is “lot-completed”. As a result, each of the button B41, the button B42, and the button B44 is grayed out. In this case, for example, when a selection operation is performed on the button B46, the server 30 causes the terminal device 40 to display the print user information reception image P7 for receiving user identification information and user name information of a user who prints a label of a lot indicated by each of all the pieces of lot information.

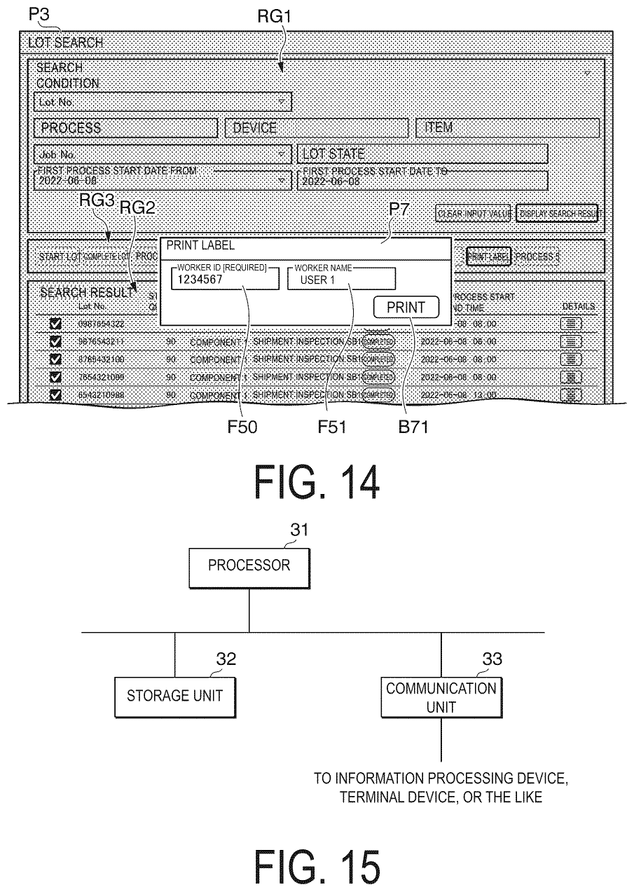

FIG. 14 is a diagram illustrating an example of the print user information reception image P7 displayed on the terminal device 40 when a selection operation is performed on the button B46 illustrated in FIG. 13.

The print user information reception image P7 includes, for example, an input field F50, an input field F51, and a button B71. Note that the print user information reception image P7 may be configured to include other GUIs instead of some or all of these GUIs or in addition to all of these GUIs.

The input field F50 is a field in which user identification information for identifying a user is input. A character string “WORKER ID” superimposed on the input field F50 in FIG. 14 is a character string for indicating to the user that information input in the input field F50 is user identification information. Then, in the example illustrated in FIG. 14, “1234567” is input in the input field F50 as the user identification information. Note that the user identification information may be input in the input field F50 by selecting the user identification information from a pull-down menu, or may be directly input via an input device such as a keyboard.

The input field F51 is a field in which user name information indicating a name of a user is input. A character string “WORKER NAME” superimposed on the input field F51 in FIG. 14 is a character string for indicating to the user that information input in the input field F51 is user name information. Then, in the example illustrated in FIG. 14, “USER 1” is input as the user name information in the input field F51. Note that the user name information may be input in the input field F51 by selecting the user name information from a pull-down menu, or may be directly input via an input device such as a keyboard.

The button B71 is a button for receiving an operation of confirming printing of a label of a lot indicated by each of one or more pieces of lot information selected in the search result display region RG2. When a selection operation is performed on the button B71, the server 30 performs printing of the label of the lot indicated by each of the one or more pieces of lot information selected in the search result display region RG2. Accordingly, a user of the terminal device 40 can collectively reprint labels of respective one or more lots when lot information is updated, a label of a lot is forgotten to be output, a label of a lot is lost, or the like.

Although the server 30 that can cause the terminal device 40 to display the lot search image P3 as described above is, for example, a workstation, a desktop personal computer (PC), notebook PC or the like, but the present disclosure is not limited thereto. The server 30 may be configured integrally with the information processing device 20.

The server 30 is communicably connected to the information processing device 20 by wired or wireless communication. A communication network coupling the server 30 and the information processing device 20 may be, for example, a LAN in a facility in which a plurality of the managed devices 10 are installed, the Internet, a mobile communication network, or another communication network. In the following description, as an example, a case in which a communication network coupling the server 30 and the information processing device 20 is the Internet will be described. In this case, the server 30 is a cloud server.

Further, the server 30 is communicably connected to the terminal device 40 by wired or wireless communication. In the example illustrated in FIG. 1, the server 30 is communicably connected to the terminal device 40 through wireless communication. A communication network coupling the server 30 and the terminal device 40 may be, for example, a LAN in a facility in which the server 30 is installed, the Internet, a mobile communication network, or another communication network. In the following description, as an example, a case in which the communication network coupling the server 30 and the terminal device 40 is the Internet will be described.

### Hardware Configuration of Server

A hardware configuration of the server 30 will be described below with reference to FIG. 15. FIG. 15 is a diagram illustrating an example of the hardware configuration of the server 30.

The server 30 includes, for example, a processor 31, a storage unit 32, and a communication unit 33. These constituent elements are coupled through a bus in a manner that they can communicate with each other. Further, the server 30 communicates with each of the information processing device 20 and the terminal device 40 via the communication unit 33.

The processor 31 is, for example, a central processing unit (CPU). Note that, instead of the CPU, the processor 31 may be another processor such as a field programmable gate array (FPGA). The processor 31 executes various types of programs stored in the storage unit 32.

The storage unit 32 is a storage device including, for example, a hard disk drive (HDD), a solid state drive (SSD), an electronically erasable programmable read only memory (EEPROM), a read only memory (ROM), a random access memory (RAM), or the like. Note that, rather than being included within the server 30, the storage unit 32 may be an externally provided storage device coupled through a digital input-output port or the like such as a Universal Serial Bus (USB). The storage unit 32 stores various types of information, various images, and various programs to be processed by the server 30.

The communication unit 33 is a communication device configured to include, for example, a digital input-output port such as a USB, an Ethernet (registered trademark) port, an antenna for wireless communication, and the like.

### Functional Configuration of Server

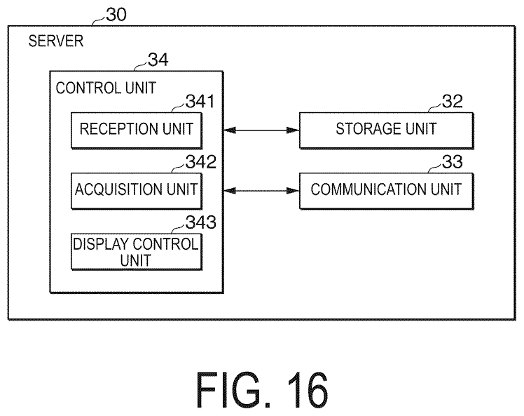

A functional configuration of the server 30 will be described below with reference to FIG. 16. FIG. 16 is a diagram illustrating an example of the functional configuration of the server 30.

The server 30 includes the storage unit 32, the communication unit 33, and a control unit 34.

The control unit 34 controls the entire server 30. The control unit 34 includes a reception unit 341, an acquisition unit 342, and a display control unit 343. These functional units included in the control unit 34 are achieved, for example, when the processor 31 executes various programs stored in the storage unit 32. In addition, some or all of the functional units may be hardware functional units such as large-scale integration (LSI), an application specific integrated circuit (ASIC), and the like.

The reception unit 341 receives various types of information and various types of operations from a device communicably connected to the server 30.

For each of the plurality of managed devices 10, the acquisition unit 342 acquires state information about the managed device 10 from the managed device 10 via the information processing device 20. The acquisition unit 342 may be configured to directly acquire the state information from the managed device 10 not via the information processing device 20.

The display control unit 343 generates various images according to an operation received via the reception unit 341. The display control unit 343 transmits the generated images to the terminal device 40 and causes the terminal device 40 to display the images.

### Processing by Server for Performing Lot Search

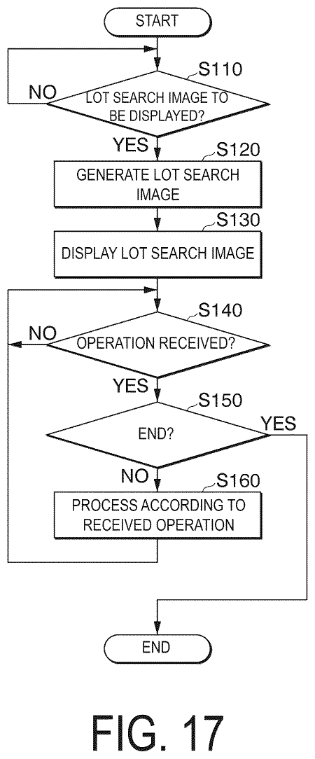

Referring to FIG. 17, processing by the server 30 for performing a lot search will be described. FIG. 17 is a diagram illustrating an example of a flow of the processing by the server 30 for performing a lot search. In the following description, as an example, a description will be made of a case in which the terminal image P2 is displayed on the terminal device 40 at a time before a process in step S110 illustrated in FIG. 17 is performed. In addition, in the following description, as an example, a description will be made of a case in which, at the time, each of master data and lot information is already stored in the server 30.

The control unit 34 waits until an operation of causing the lot search image P3 to be displayed is received via the terminal device 40 (step S110).

When the control unit 34 determines that an operation of causing the lot search image P3 to be displayed is received via the terminal device 40 (YES: step S110), the control unit 34 generates the lot search image P3 (step S120). A method of generating the lot search image P3 in step S120 may be a known method, or may be a method to be developed hereinafter.

Next, the control unit 34 transmits the lot search image P3 generated in step P120 to the terminal device 40, and causes the terminal device 40 to display the lot search image P3 (step S130).

Next, the control unit 34 waits until an operation is received via the lot search image P3 displayed on the terminal device 40 (step S140).

When the control unit 34 determines that an operation is received via the lot search image P3 displayed on the terminal device 40 (YES: step S140), the control unit 34 determines whether the received operation is an operation of ending the processing of the flowchart illustrated in FIG. 17 or not (step S150). The determination process in step S150 by the control unit 34 may be performed by a known method or may be performed by a method to be developed hereinafter.

When the control unit 34 determines that the operation received in step S140 is the operation of ending the processing of the flowchart illustrated in FIG. 17 (step S150: YES), the control unit 34 deletes the display of the lot search image P3 from the terminal device 40, for example, and ends the processing of the flowchart illustrated in FIG. 17.

On the other hand, when the control unit 34 determines that the operation received in step S140 is not the operation of ending the processing of the flowchart illustrated in FIG. 17 (step S150: NO), the control unit 34 performs a process corresponding to the received operation (step S160). Here, since the process performed by the control unit 34 in step S160 has been described in the description of FIG. 4 to FIG. 14, a detailed description thereof will be omitted.

After the process in step S160 is performed, the control unit 34 transitions to step S140 and waits again until an operation is received via the lot search image P3 displayed on the terminal device 40.

According to the processing described above, when at least one piece of information among one or more pieces of information included in lot related information is received via the lot search image P3, the server 30 causes the terminal device 40 to display lot information indicating a lot identified by each of the one or more pieces of lot identification information associated with the at least one piece of information received. As a result, the server 30 can cause a user to easily search for information about a product of a lot desired by the user. As a result, the server 30 can improve traceability of a product.

Note that the molding management system 1 described above may be configured to include the terminal device 40.

In addition, the lot search described above may be performed using a time zone in which a lot is not normally operated as a search key. In this case, lot related information includes information indicating the time zone.

Further, the lot search described above may be performed using one or more pieces of information included in injection molding device related information as a search key. In this case, lot related information includes the injection molding device related information. Injection molding device related information included in lot related information related to a certain lot is information related to an injection molding device that performs molding of a product of the lot, and is, for example, information including operation state information indicating an operation state of the injection molding device, detection information about the injection molding device, and the like. Accordingly, the server 30 can more reliably improve traceability of a product.

Further, the lot search described above may be performed using a freely selected character string as a search key. In this case, the lot search image P3 includes an input field for a user to input a character string. Then, when a character string is received via the input field, the server 30 specifies information including the received character string from among one or more pieces of information included in lot related information, and causes lot information indicating a lot identified by each lot identification information associated with the specified information to be displayed in the search result display region RG2. Accordingly, the server 30 can further facilitate a lot search by the user.

Further, the contents described above may be combined in any manner.

### Supplementary Notes

(1)

A molding management system that includes a server communicably connected to a terminal device and manages production of a product in a production process including an injection molding process of the product by an injection molding device, wherein the server includes a storage unit that stores lot identification information for identifying a lot of the product and lot related information including one or more pieces of information related to the lot of the product in association with each other, and a control unit that displays, on the terminal device, a lot search image for receiving a search operation of searching for the lot of the product from the terminal device, and the control unit, when at least one piece of information among the one or more pieces of information included in the lot related information is received via the lot search image by the search operation, displays, on the terminal device, lot information indicating the lot identified by each of one or more pieces of the lot identification information associated with the at least one piece of information received.

(2)

The molding management system according to (1), wherein the lot related information includes, as the one or more pieces of information, injection molding device related information related to an injection molding device that molds the product of the lot identified by the lot identification information associated with the lot related information, and the injection molding device related information includes at least one of operation state information indicating an operation state of the injection molding device and detection information detected by each of one or more sensors attached to the injection molding device.

(3)

The molding management system according to (1) or (2), wherein the lot related information includes quality information about the product of the lot identified by the lot identification information associated with the lot related information.

(4)

The molding management system according to any one of (1) to (3), wherein when a character string is received via the lot search image, the control unit specifies, from the one or more pieces of information, information including the character string received, and displays, on the terminal device, the lot information indicating the lot identified by each of one or more pieces of the lot identification information associated with the specified information.

(5)

The molding management system according to any one of (1) to (4), wherein the control unit displays a GUI for receiving a processing performance operation of starting, by the server, performance of predetermined processing on the lot indicated by each of one or more pieces of the lot information selected in accordance with a lot information selection operation received among one or more pieces of the lot information displayed on the terminal device.

(6)

The molding management system according to (5), wherein the control unit grays out the GUI when a predetermined gray-out condition is satisfied.

(7)

The molding management system according to any one of (1) to (6), including the terminal device.

(8)

The molding management system according to any one of (1) to (7), including the injection molding device.

These are detailed description of the embodiment according to the present disclosure with reference to the drawings. However, specific configurations are not limited to this embodiment, and may be modified, replaced, deleted, or the like, provided that these do not depart from the main point of the present disclosure.

In addition, a program for achieving the functions of any constituent units of the device described above may be recorded in a computer-readable recording medium, and the program may be read and executed by a computer system. Here, the device is, for example, the injection molding device 11, the information processing device 20, the server 30, the terminal device 40, or the like. Note that the “computer system” as used here is assumed to include hardware such as an operating system (OS) or a peripheral apparatus. In addition, the “computer-readable recording medium” represents a portable medium such as a flexible disk, a magneto-optical disk, a ROM, a compact disc (CD)-ROM, and a storage device such as a hard disk built into a computer system. Furthermore, the “computer-readable recording medium” is assumed to include a medium that holds a program for a certain period of time, which includes a volatile memory provided inside of a computer system serving as a server or a client when the program is transmitted via a network such as the Internet or a communication line such as a telephone line.

In addition, the program described above may be transmitted via a transmission medium from a computer system storing the program in a storage device or the like, or to another computer system using transmission waves in a transmission medium. Here, the “transmission medium” used to transmit a program represents a medium having a function of transmitting information, as with a network such as the Internet or a communication line such as a telephone line.

In addition, the program described above may be a program used to achieve a portion of the functions described above. Furthermore, the program described above can be a so-called differential file or a differential program that can achieve the functions described above in combination with a program that has already been recorded in the computer system.

What is claimed is:

1. A molding management system that includes a server communicably connected to a terminal device and manages production of a product in a production process including an injection molding process of the product by an injection molding device, wherein
the server includes
a storage unit that stores lot identification information for identifying a lot of the product and lot related information including one or more pieces of information related to the lot of the product in association with each other and
a control unit that displays, on the terminal device, a lot search image for receiving a search operation of searching for the lot of the product from the terminal device, and
the control unit, when at least one piece of information among the one or more pieces of information included in the lot related information is received via the lot search image by the search operation, displays, on the terminal device, lot information indicating the lot identified by each of one or more pieces of the lot identification information associated with the at least one piece of information received.

2. The molding management system according to claim 1, wherein
the lot related information includes, as the one or more pieces of information, injection molding device related information related to an injection molding device that molds the product of the lot identified by the lot identification information associated with the lot related information, and
the injection molding device related information includes at least one of operation state information indicating an operation state of the injection molding device and detection information detected by each of one or more sensors attached to the injection molding device.

3. The molding management system according to claim 1, wherein
the lot related information includes quality information about the product of the lot identified by the lot identification information associated with the lot related information.

4. The molding management system according to claim 1, wherein
when a character string is received via the lot search image, the control unit specifies, from the one or more pieces of information, information including the character string received, and displays, on the terminal device, the lot information indicating the lot identified by each of one or more pieces of the lot identification information associated with the specified information.

5. The molding management system according to claim 1, wherein
the control unit displays a GUI for receiving a processing performance operation of starting, by the server, performance of predetermined processing on the lot indicated by each of one or more pieces of the lot information selected in accordance with a lot information selection operation received among one or more pieces of the lot information displayed on the terminal device.

6. The molding management system according to claim 5, wherein
the control unit grays out the GUI when a predetermined gray-out condition is satisfied.

7. The molding management system according to claim 1 comprising the terminal device.

8. The molding management system according to claim 1 comprising the injection molding device.
